(19) United States
(12) Patent Application Publication
(10) Pub. No.: US 2010/0045945 A1
(43) Pub. Date: Feb. 25, 2010

(54) Lens-Adjusting Module

(76) Inventor: Yung-Chuan TSENG, Hsin-Chu (TW)

Correspondence Address: LanWay IPR Services, P.O. box 223205, Chantilly, VA, 20153, US

(21) Appl. No.: 12/539,638

(22) Filed: Aug. 12, 2009

(30) Foreign Application Priority Data
Aug. 20, 2008 (TW) 097131807
Apr. 28, 2009 (TW) 098114109

(51) Int. Cl. G02B 7/02

(52) U.S. Cl. 353/101; 359/811

(57) ABSTRACT

A lens-adjusting module includes a base, a tray movably disposed on the base, a lens fixed at the tray, and an adjusting device including a casing, a worm, a transmission gear, and a transmission element. The casing is fixed at the base. The worm is pivoted at the casing. The transmission gear is pivoted at the casing and geared to the worm. The transmission element is fixed at the transmission gear and connected to the tray. When the worm rotates such that the transmission gear rotates, the transmission gear drives the transmission element such that the tray moves relatively to the base along an axis. The disposition of the elements of the lens-adjusting module may satisfy a designing requirement of a designer for space planning.

This application claims priority to a Taiwan application No. 097131807 filed on Aug. 20, 2008 and a Taiwan application No. 098114109 filed on Apr. 28, 2009.

### BACKGROUND

1. Field of the Invention

The present invention relates generally to a lens-adjusting module. More particularly, the present invention relates to the lens-adjusting module applied to a projector.

2. Detailed Description of the Related Art

FIG. 1 is a schematic view of a conventional projector. FIG. 2 is a schematic view of the lens-adjusting module of FIG. 1. Please refer to FIGS. 1 and 2. The conventional projector P1 includes a lens-adjusting module 100, a light valve 200, an illumination module 300, and a cover 400. The illumination module 300 disposed in the cover 400 provides an illumination beam 310. The light valve 200 is disposed in the cover 400 and located in the transmission path of the illumination beam 310. The light valve 200 converts the illumination beam 310 into an image beam 210. The lens-adjusting module 100 is disposed in the cover 400 and a lens 170 of the lens-adjusting module 100 is located in the transmission path of the image beam 210 to project the image beam 210 to a screen (not shown).

Please refer to FIG. 2, the lens-adjusting module 100 further includes a base 120, two first guiding shaft 130, a first adjusting stand 140, two second guiding shaft 150, and a second adjusting stand 160 besides the lens 170. The first guiding shafts 130 are disposed at the two opposite sides of the base 120 respectively. The first adjusting stand 140 is installed on the first guiding shafts 130. The second guiding shafts 150 are disposed at the two opposite sides of the first adjusting stand 140. The second adjusting stand 160 is installed on the second guiding shafts 150. Each of the first guiding shafts 130 extends along a first axis A1. Each of the second guiding shafts 150 extends along a second axis A2. The first axis A1 is perpendicular to the second axis A2.

The lens 170 is disposed on the second adjusting stand 160. The second adjusting stand 160 of the lens-adjusting module 100 may move along the second axis A2 and the first adjusting stand 140 may move along the first axis A1 such that the lens 170 is adjusted by means of moving the first adjusting stand 140 and the second adjusting stand 160.

According to the lens-adjusting module 100, adjusting the lens 170 is achieved by means of the arrangement of the guiding shafts 130 and 150 and the adjusting stand 140 and 160. However, the arrangement of the elements in the lens-adjusting module 100 may not satisfy another designer having another requirement of space planning for inside of another projector.

In addition, because the guiding shafts 130 and 150 and the first adjusting stand 140 are all disposed between the base 120 and the second adjusting stand 160, the cumulative tolerance between the second adjusting stand 160 and the base 120 is relatively large after the lens-adjusting module 100 is assembled. Accordingly, the predetermined interval between the second adjusting stand 160 and the base 120 is adversely affected by the cumulative tolerance such that an image projected by the lens 170 disposed at the second adjusting stand 160 is out of focus.

### BRIEF SUMMARY

The present invention is directed to provide a lens-adjusting module in which the arrangement of the elements may satisfy another designer having another requirement of space planning.

The present invention is directed to provide a lens-adjusting module of which the cumulative tolerance is relatively low after the lens-adjusting module is assembled.

Other advantages and objects of the present invention may be further comprehended through the technical features disclosed in the present invention.

In order to achieve one or part of or all the objectives or other objectives, in an embodiment of the present invention, the lens-adjusting module includes a base, a tray, a lens, and an adjusting device. The tray is movably disposed on the base. The lens is fixed at the tray.

The adjusting device includes a casing, a first worm, a first transmission gear, and a first transmission element. The casing is fixed at the base. The first worm is pivoted at the casing. The first transmission gear is pivoted at the casing and geared to the first worm. The first transmission element is fixed at the first transmission gear and connected to the tray. When the first worm rotates such that the first transmission gear rotates, the first transmission gear drives the first transmission element such that the tray moves relatively to the base along a first axis.

Because the arrangement of the elements in the lens-adjusting module of the embodiment of the present invention is different from that of the elements in the lens-adjusting module of the conventional art, a designer may use the lens-adjusting module of the embodiment of the present invention according to the designer's requirement of spacing planning. Therefore, the arrangement of the elements in the lens-adjusting module of the embodiment of the present invention may satisfy another designer having another requirement of space planning.

In addition, because the lens of the lens-adjusting module of the embodiment of the present invention may be directly disposed on the tray and the tray may be directly disposed on the base, compared with the conventional art, the cumulative tolerance between the tray and the base is reduced after the lens-adjusting module is assembled. Accordingly, the predetermined interval between the tray and the base is comparatively not adversely affected by the cumulative tolerance such that an image projected by the lens disposed at the tray is comparatively not out of focus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic view of a conventional projector.

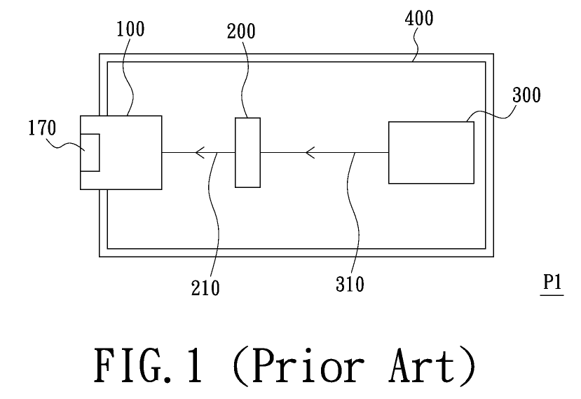

FIG. 2 is a schematic view of the lens-adjusting module of FIG. 1.

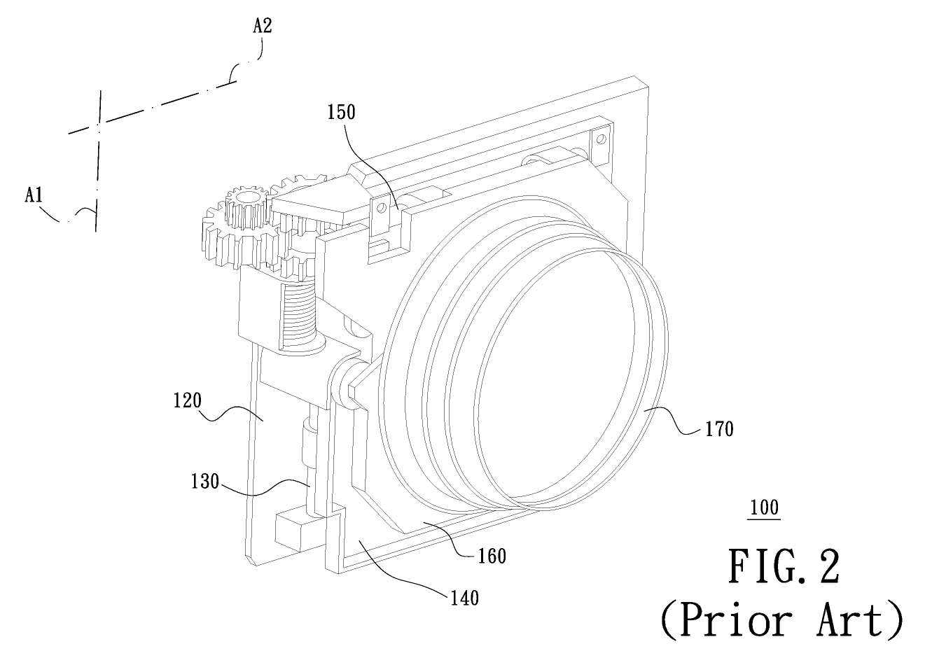

FIG. 3 is a schematic view of a projector of a first embodiment of the present invention.

FIG. 4A is a schematic assembly view of the lens-adjusting module of FIG. 3.

FIG. 4B is a schematic explosion view of the lens-adjusting module of FIG. 4A.

FIG. 5 is a schematically detailed explosion view of the tray and the anti-dust ring of FIG. 4B.

FIG. 6A is a schematically detailed explosion view of the adjusting device of FIG. 4B.

FIG. 6B is another schematic view of the adjusting device of FIG. 4B.

FIG. 7 is a schematic view showing the connection between the adjusting device and the tray of FIG. 4B.

FIG. 8A is a schematic view showing that the first tray body of the first embodiment is at a first position relative to the second tray body.

FIG. 8B is a schematic view showing that the first tray body of the first embodiment is at a second position relative to the second tray body.

FIG. 9 is a schematic explosion view of a lens-adjusting module of a second embodiment of the present invention.

FIG. 10A is a schematically detailed explosion view of the tray of FIG. 9.

FIG. 10B is another schematically detailed explosion view of the tray of FIG. 9.

FIG. 11 is a schematically detailed explosion view of the adjusting device of FIG. 9.

FIG. 12 is a schematic view showing the connection between the adjusting device and the tray of FIG. 9.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

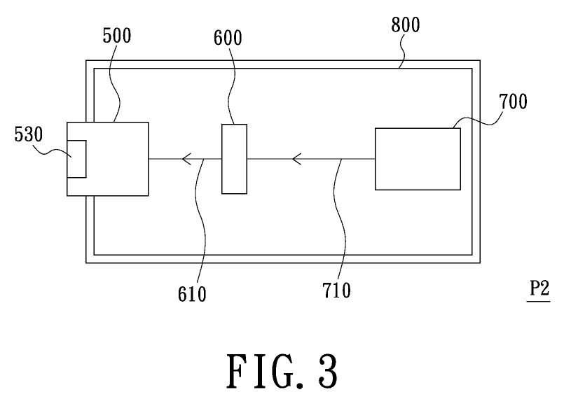

FIG. 3 is a schematic view of a projector of a first embodiment of the present invention. Please refer to FIG. 3. The projector of the present embodiment P2 includes a lens-adjusting module 500, a light valve 600, an illumination module 700, and a cover 800. The illumination module 700 disposed in the cover 800 provides an illuminating light beam 710. The light valve 600 is disposed in the cover 800 and located in the transmission path of the illuminating light beam 710. The light valve 600 converts the illuminating light beam 710 into an image light beam 610. The lens-adjusting module 500 is disposed at the cover 800 and a lens 530 of the lens-adjusting module 500 is located in the transmission path of the image light beam 610 to project the image beam 610 to a screen (not shown).

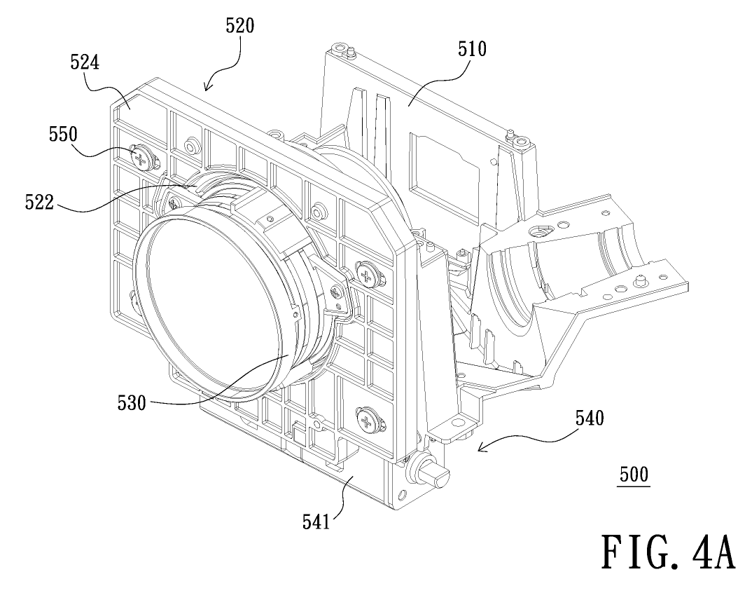

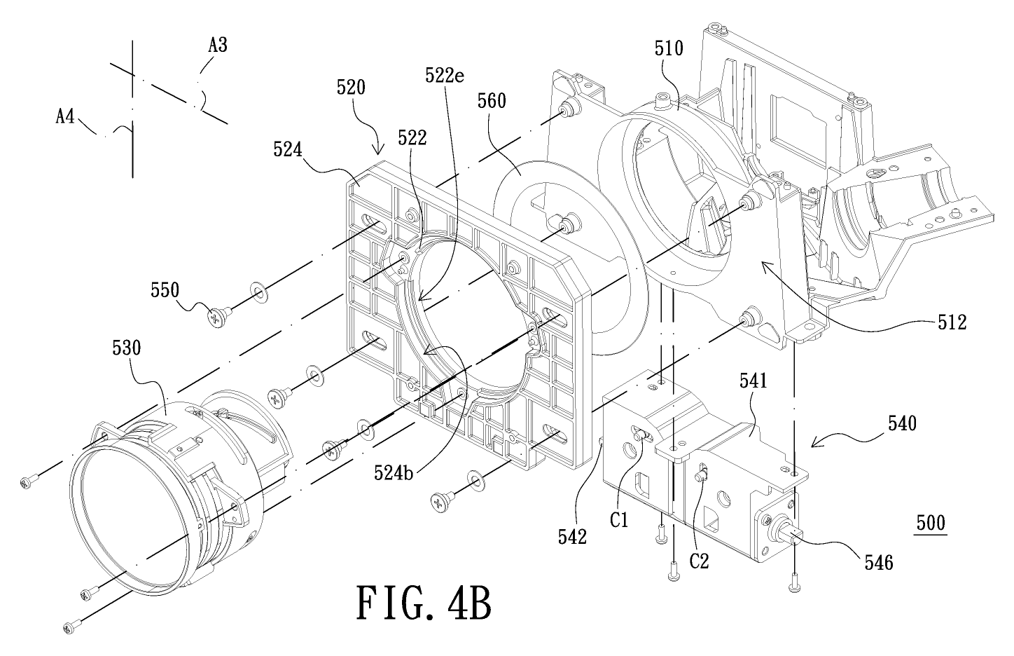

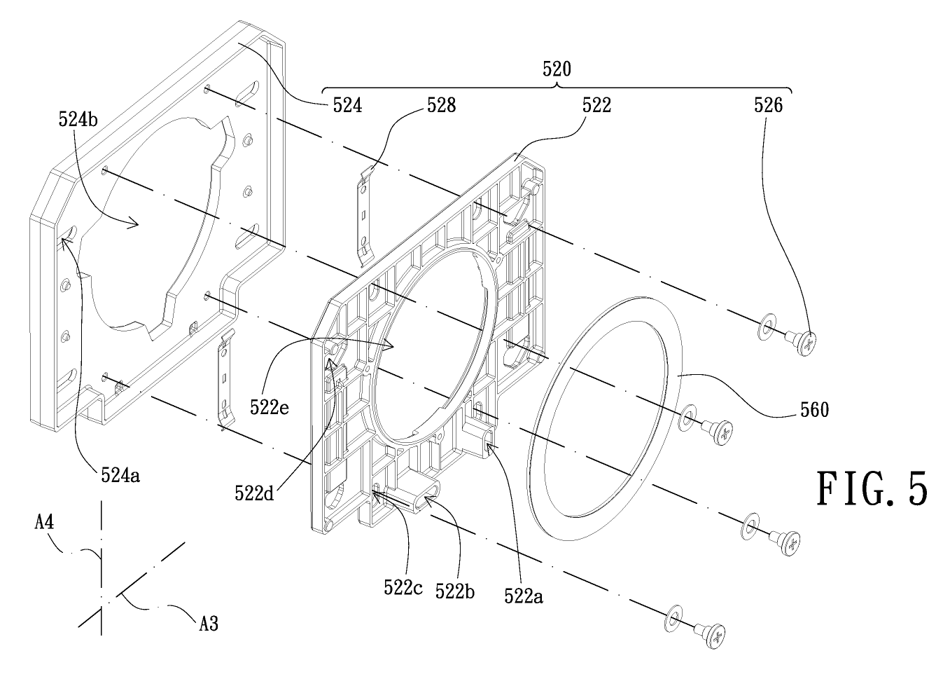

FIG. 4A is a schematic assembly view of the lens-adjusting module of FIG. 3. FIG. 4B is a schematic explosion view of the lens-adjusting module of FIG. 4A. FIG. 5 is a schematically detailed explosion view of the tray and the anti-dust ring of FIG. 4B. Please refer FIGS. 4A, 4B and 5, the lens-adjusting module 500 further includes a base 510, a tray 520, and an adjusting device 540 besides the lens 530. The tray 520 is movably disposed on the base 510 and the lens 530 is fixed at the tray 520. As regards the tray 520, the tray 520 includes a first tray body 522, a second tray body 524, a plurality of first sliding blocks 526, and at least one elastic piece 528 (two elastic pieces 528 are schematically shown in FIG. 5). The first tray body 522 has a first sliding trench 522a, a second sliding trench 522b, a plurality of third sliding trenches 522c, and a plurality of holes 522d. The second tray body 524 has a plurality of fourth sliding trenches 524a and the fourth sliding trenches 524a are corresponding to the holes 522d respectively. The elastic pieces 528 are disposed between the first tray body 522 and the second tray body 524 to reduce the friction between the first tray body 522 and the second tray body 524 (see the detailed following description).

The first sliding trench 522a of the first tray body 522 extends along a second axis A4, the second sliding trench 522b extends along a first axis A3 and each of the third sliding trenches 522c extends along the second axis A4. The first axis A3 is perpendicular to the second axis A4. Each of the fourth sliding trenches 524a of the second tray body 524 extends along the first axis A3. The first sliding blocks 526 such as screws are capable of passing through the third sliding trenches 522c respectively to be fixed at the second tray body 524 such that the first tray body 522 is movably disposed on the second tray body 524. In addition, in the present embodiment, the lens 530 is capable of passing through a first opening 524b of the second tray body 524 and a second opening 522e of the first tray body 522 and the lens 530 is fixed at the first tray body 522. In brief, the lens 530 of the present embodiment may be directly fixed at the first tray body 522.

As regards the disposition of the tray 520 and the base 510, in the present embodiment, the lens-adjusting module 500 further includes a plurality of second sliding blocks 550 such as screws and an anti-dust ring 560. The second sliding blocks 550 pass through the fourth sliding trenches 524a and the holes 522d respectively to be fixed at the base 510 such that the tray 520 is movably disposed on the base 510. In brief, the tray 520 of the present embodiment may be directly disposed on the base 510. In addition, the elastic pieces 528 may exert force on the first tray body 522 such that the first tray body 522 lean closely against a foundation plane 512 of the base 510. Besides, the anti-dust ring 560 is disposed between the base 510 and the first tray body 522 and surrounds the second opening 522e to prevent foreign bodies from entering.

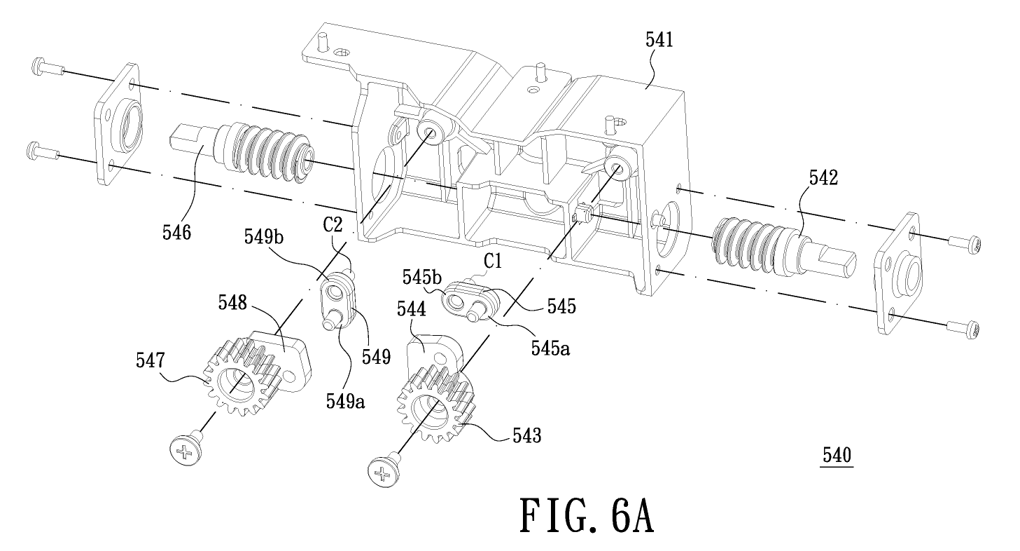

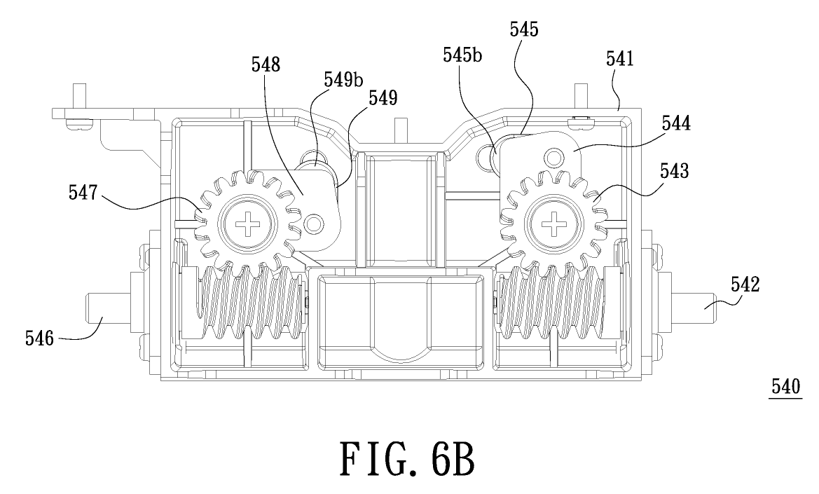

FIG. 6A is a schematically detailed explosion view of the adjusting device of FIG. 4B. FIG. 6B is another schematic view of the adjusting device of FIG. 4B. Please refer to FIGS. 4A, 4B, 6A and 6B, as regards the adjusting device 540, the adjusting device 540 includes a casing 541, a first worm 542, a first transmission gear 543, a first transmission element 544, a first transmission link 545, a second worm 546, a second transmission gear 547, a second transmission element 548, and a second transmission link 549. The casing 541 is fixed at the base 510. The first worm 542 is pivoted at the casing 541. The first transmission gear 543 such as a helical gear is pivoted at the casing 541 and geared to the first worm 542. The first transmission element 544 is fixed at the first transmission gear 543. The first transmission link 545 has a first end 545a and a second end 545b, the first end 545a is pivoted at the first transmission element 544 and the second end 545b has a first cylinder C1 passing through the casing 541.

In addition, the second worm 546 is pivoted at the casing 541. The second transmission gear 547 such as a helical gear is pivoted at the casing 541 and geared to the second worm 546. The second transmission element 548 is fixed at the second transmission gear 547. The second transmission link 549 has a third end 549a and a fourth end 549b, the third end 549a is pivoted at the second transmission element 548 and the fourth end 549b has a second cylinder C2 passing through the casing 541.

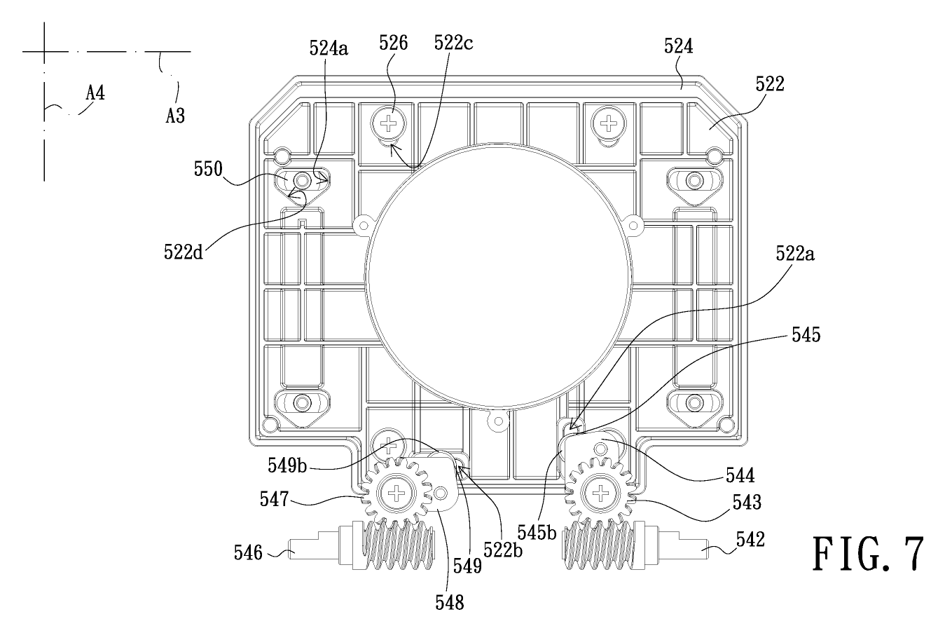

FIG. 7 is a schematic view showing the connection between the adjusting device and the tray of FIG. 4B. It should be noted that for the convenience of illustration, part of the elements of the adjusting device 540 are only schematically shown in FIG. 7. Please refer to FIGS. 4B, 6A, 6B and 7, as regards the connection between the adjusting device 540 and the tray 520, the second end 545b of the first transmission link 545 is slidingly connected to the first tray body 522 of the tray 520, for example, the first cylinder C1 of the second end 545b of the first transmission link 545 is disposed at the first sliding trench 522a of the first tray body 522 of the tray 520. To sum up, the first transmission element 544 is slidingly connected to the first tray body 522 of the tray 520 through the first transmission link 545. It should be noted that the meaning of that the first transmission element 544 is slidingly connected to the first tray body 522 of the tray 520 through the first transmission link 545 is that the first transmission element 544 is connected to the first tray body 522 of the tray 520 through the first transmission link 545 and that there may be relative linear motion between first tray body 522 and the first transmission element 544 when the first transmission element 544 operates. The more detailed operation is described below.

In addition, the fourth end 549b of the second transmission link 549 is slidingly connected to first tray body 522, for example, the second cylinder C2 of the fourth end 549b of the second transmission link 549 is disposed at the second sliding trench 522b of the first tray body 522. To sum up, the second transmission element 548 is slidingly connected to the first tray body 522 of the tray 520 through the second transmission link 549.

Because the arrangement of the elements in the lens-adjusting module 500 is different from that of the elements in the lens-adjusting module 100 of the conventional art, a designer may use the lens-adjusting module 500 according to the designer's requirement of spacing planning. Therefore, the arrangement of the elements in the lens-adjusting module 500 may satisfy another designer having another requirement of space planning.

In addition, because the lens 530 may be directly disposed on the tray 520 and the tray 520 may be directly disposed on the base 510, compared with the conventional art, the cumulative tolerance between the tray 520 and the base 510 is reduced after the lens-adjusting module 500 is assembled. Accordingly, the predetermined interval between the tray 520 and the base 510 is comparatively not adversely affected by the cumulative tolerance such that an image projected by the lens 530 disposed at the tray 520 is comparatively not out of focus.

The operation of the lens-adjusting module 500 is described in following. Please refer to FIGS. 4A, 4B, 5, 6A, 6B and 7, when the first worm 542 rotates such that the first transmission gear 543 rotates, the first transmission gear 543 drives the first transmission element 544 to drive the first transmission link 545 such that the first tray body 522 and the second tray body 524 move together relatively to the base 510 and move along the first axis A3. At this time, the fourth sliding trenches 524a and the corresponding holes 522d move relatively to the corresponding second sliding blocks 550 and the second sliding trench 522b also move relatively to the second cylinder C2 of the fourth end 549b of the second transmission link 549.

When the second worm 546 rotates such that the second transmission gear 547 rotates, the second transmission gear 547 moves the second transmission element 548 to drive the second transmission link 549 such that the second tray body 524 moves relatively to the first tray body 522 and moves along the second axis A4. At this time, the elastic pieces 528 disposed between the first tray body 522 and the second tray body 524 may reduce the friction between the first tray body 522 and the second tray body 524, the third sliding trenches 522c move relatively to the corresponding first sliding blocks 526 and the first sliding trench 522a also moves relatively to the first cylinder C1 of the second end 545b of the first transmission link 545. According to the mentioned above, a user may adjust the lens 530 to move the lens 530 along the first axis A3 or the second axis A4 by means of rotating the first worm 542 or the second worm 546.

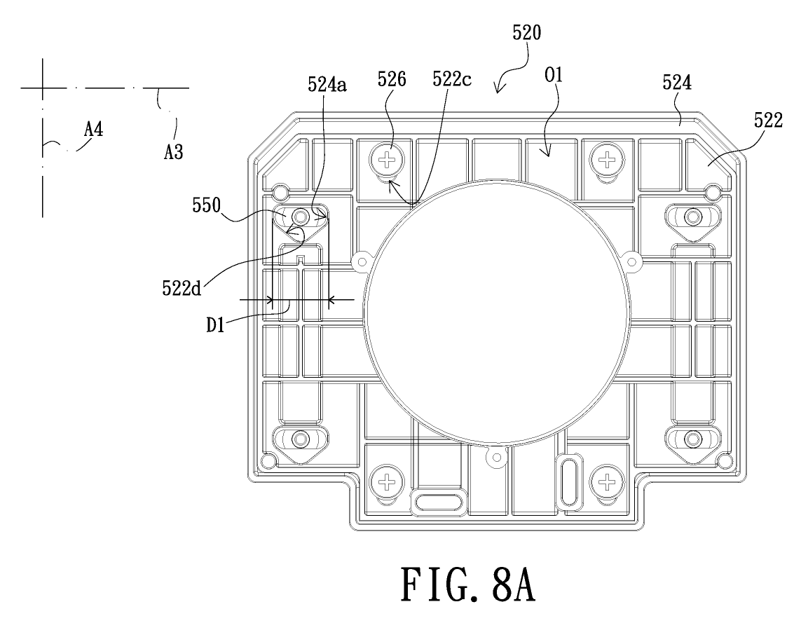

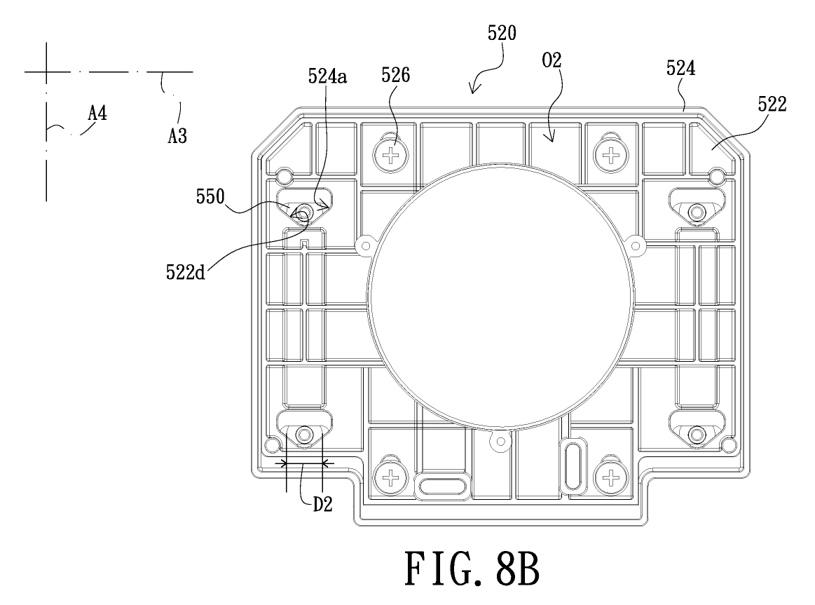

FIG. 8A is a schematic view showing that the first tray body of the first embodiment is at a first position relative to the second tray body. FIG. 8B is a schematic view showing that the first tray body of the first embodiment is at a second position relative to the second tray body. Please refer to FIGS. 8A and 8B, when the first tray body 522 is at a first position O1 relative to the second tray body 524, the tray 520 limited by the holes 522d has a first move distance D1 along the first axis A3. When the first tray body 522 is at a second position O2 relative to the second tray body 524, the tray 520 limited by the holes 522d has a second move distance D2 along the first axis A3. The first move distance D1 is different from the second move distance D2. It should be noted that, in another embodiment, a designer may change the shape of each of the holes 522d to be a rectangle such that the first move distance D1 is the same as the second move distance D2 but the mentioned above is not shown in any drawing.

In addition, in another embodiment, the first tray body 522 and the second tray body 524 may be designed to be fixed to each other and not move relatively to each other, for example, the first tray body 522 is adhesively connected to the second tray body 524. Besides, the second worm 546, the second transmission gear 547, the second transmission element 548 and the second transmission link 549 in the adjusting device 540 may be designed to be omitted such that the lens 530 fixed at the tray 520 only moves relatively to the base 510 along the first axis A3. However, the above mentioned is not shown in any figures.

### Second Embodiment

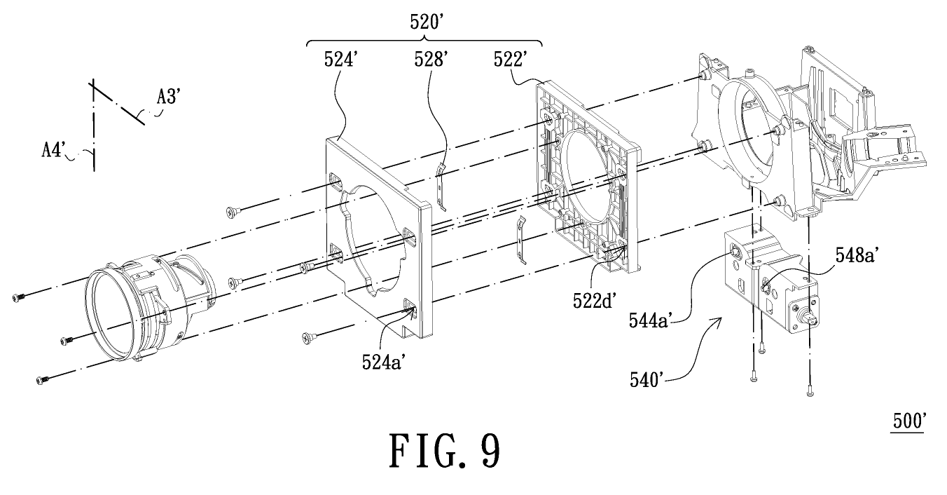

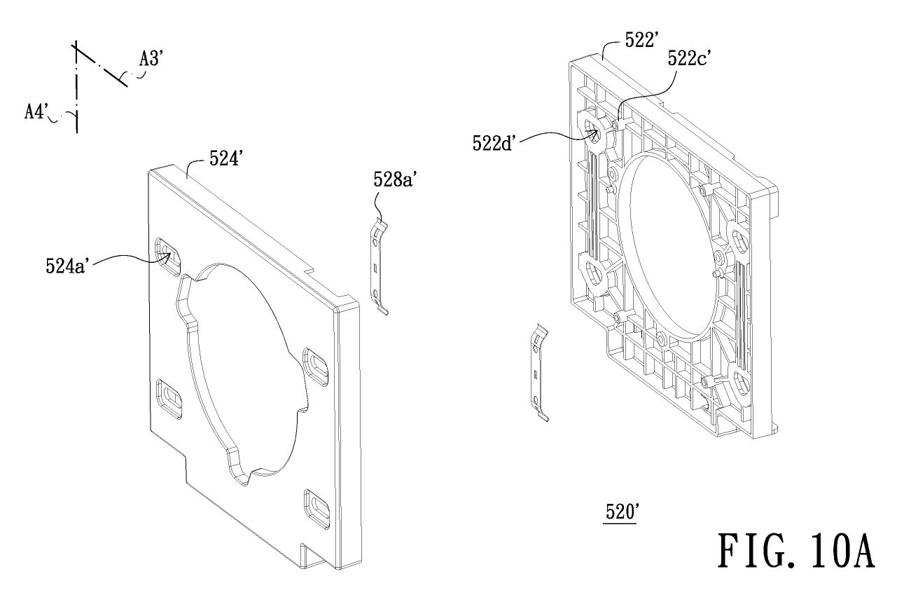

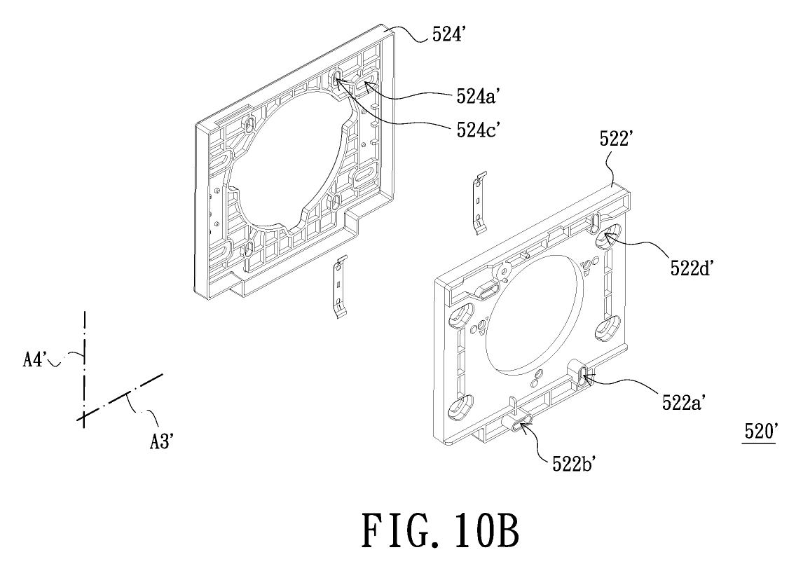

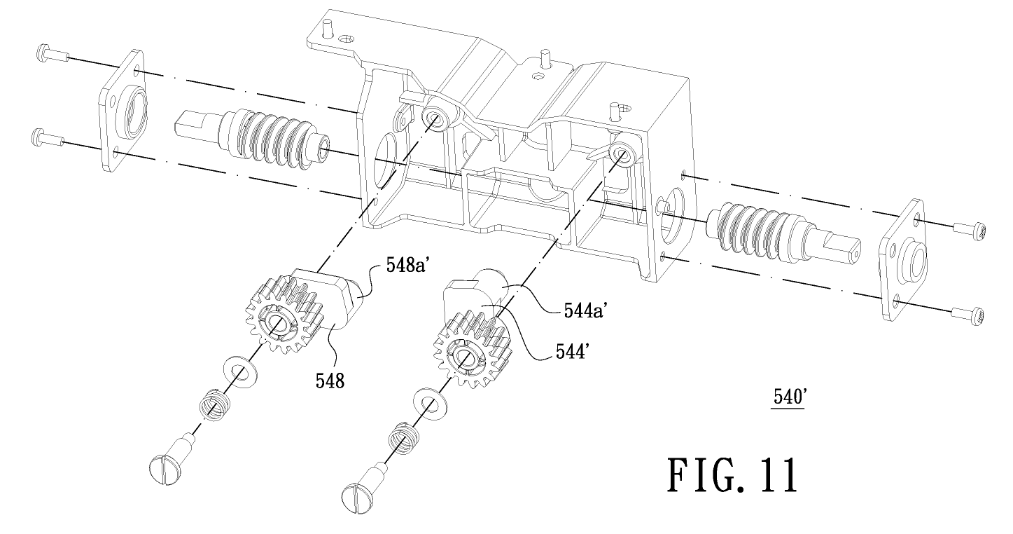

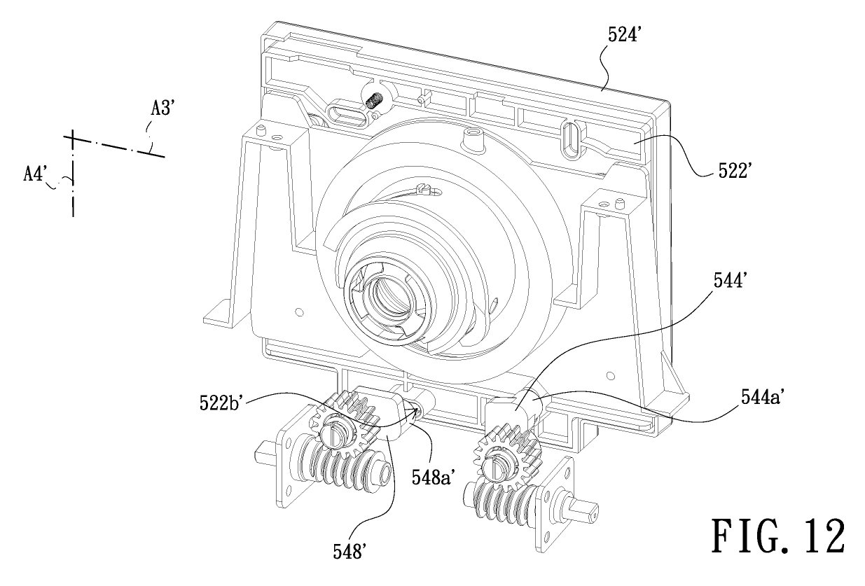

FIG. 9 is a schematic explosion view of a lens-adjusting module of a second embodiment of the present invention. FIG. 10A is a schematically detailed explosion view of the tray of FIG. 9. FIG. 10B is another schematically detailed explosion view of the tray of FIG. 9. FIG. 11 is a schematically detailed explosion view of the adjusting device of FIG. 9. FIG. 12 is a schematic view showing the connection between the adjusting device and the tray of FIG. 9. It should be noted that for the convenience of illustration, part of the elements of the adjusting device 540′ are only schematically shown in FIG. 7. Please refer to FIGS. 4B, 5, 6A, 9, 10A, 10B and 11, the main difference between the lens-adjusting module 500′ of the present embodiment and the lens-adjusting module 500 of the first embodiment lies in that the shape and the disposition of the first tray body 522′ and those of the second tray body 524′ of the tray 520′ are different from those of the first tray body 522 and those of the second tray body 524 of the tray 520 and that the first transmission link 545 and the second transmission link 549 are omitted in the adjusting device 540′.

Please refer to FIGS. 9, 10A, 10B, 11 and 12, the tray 520′ of the present embodiment includes the first tray body 522′, the second tray body 524′ and at least one elastic piece 528′ (two elastic pieces are shown in FIG. 9). The first tray body 522′ has the first sliding trench 522a′, the second sliding trench 522b′, a plurality of first sliding blocks 522c′ and a plurality of holes 522d′. The second tray body 524′ has a plurality of third sliding trenches 524c′ and a plurality of fourth sliding trenches 524a′. The fourth sliding trenches 524a′ are corresponding to the holes 522d′ respectively.

The first sliding trench 522a′ of the first tray body 522′ extends along the second axis A4′ and the second sliding trench 522b′ of the first tray body 522′ extends along the first axis A3′. Each of the third sliding trenches 524c′ of the second tray body 524′ extends along the second axis A4′ and each of the fourth sliding trenches 524a′ of the second tray body 524′ extends along the first axis A3′. The first axis A3′ is perpendicular to the second axis A4′. The first sliding blocks 522c′ of the first tray body 522′ are slidingly connected to the third sliding trenches 524c′ respectively such that the first tray body 522′ is movably disposed on the second tray body 524′.

As regards the connection between the adjusting device 540′ and the tray 520′, the first transmission element 544′ has a first cylinder 544a′ disposed at the first sliding trench 522a′. The second transmission element 548′ has a second cylinder 548a′ disposed at the second sliding trench 522b′.

According to the mentioned above, the lens-adjusting module of each of the embodiments of the present invention at least has one of the following advantages or other advantages:

1. Because the arrangement of the elements in the lens-adjusting module of each of the embodiments of the present invention is different from that of the elements in the lens-adjusting module of the conventional art, a designer may use the lens-adjusting module of each of the embodiments the present invention according to the designer's requirement of spacing planning. Therefore, the arrangement of the elements in the lens-adjusting module of each of the embodiments of the present invention may satisfy another designer having another requirement of space planning.

2. Because the lens of the lens-adjusting module of each of the embodiments of the present invention may be directly disposed at the tray and the tray may be directly disposed on the base, compared with the conventional art, the cumulative tolerance between the tray and the base is reduced after the lens-adjusting module of each of the embodiments of the present invention is assembled. Accordingly, the predetermined interval between the tray and the base is comparatively not adversely affected by the cumulative tolerance such that an image projected by the lens disposed at the tray is comparatively not out of focus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lens-adjusting module comprising:
a base;
a tray movably disposed on the base;
a lens fixed at the tray; and
an adjusting device comprising:
a casing fixed at the base;
a first worm pivoted at the casing;
a first transmission gear pivoted at the casing and geared to the first worm; and
a first transmission element fixed at the first transmission gear and connected to the tray;
wherein when the first worm rotates such that the first transmission gear rotates, the first transmission gear drives the first transmission element such that the tray moves relatively to the base along a first axis.

2. The lens-adjusting module according to claim 1, wherein the tray comprises:
a first tray body, wherein the lens is fixed at the first tray body and the first transmission element is slidingly connected to the first tray body; and
a second tray body, wherein the first tray body is movably disposed at the second tray body;
wherein the adjusting device further comprises:
a second worm pivoted at the casing;
a second transmission gear pivoted at the casing and geared to the second worm; and
a second transmission element fixed at the second transmission gear and connected to the first tray body;
wherein when the first worm rotates such that the first transmission gear rotates, the first tray body and the second tray body move together relatively to the base and move along the first axis;
wherein when the second worm rotates such that the second transmission gear rotates, the second transmission gear drives the second transmission element such that the first tray body moves relatively to the second tray body and moves along a second axis, and the second axis is perpendicular to the first axis.

3. The lens-adjusting module according to claim 2, wherein the first tray body has a first sliding trench and a second sliding trench, wherein the second sliding trench extends along the first axis, the first sliding trench extends along the second axis, the first transmission element has a first cylinder disposed at the first sliding trench, and the second transmission element has a second cylinder disposed at the second sliding trench.

4. The lens-adjusting module according to claim 2, wherein the adjusting device further comprises:
a first transmission link having a first end and a second end, wherein the first end is pivoted at the first transmission element and the second end is slidingly connected to the first tray body; and
a second transmission link having a third end and a fourth end, wherein the third end is pivoted at the second transmission element and the fourth end is slidingly connected to first tray body;
wherein when the first worm rotates such that the first transmission gear rotates, the first transmission element drives the first transmission link such that the first tray body and the second tray body move together relatively to the base and move along the first axis;
wherein when the second worm rotates such that the second transmission gear rotates, the second transmission element drives the second transmission link such that the first tray body moves relatively to the second tray body and moves along the second axis.

5. The lens-adjusting module according claim 4, wherein the first tray body has a first sliding trench and a second sliding trench, wherein the second sliding trench extends along the first axis, the first sliding trench extends along the second axis, the second end of the first transmission link has a first cylinder disposed at the first sliding trench, and the fourth end of the second transmission link has a second cylinder disposed at the second sliding trench.

6. The lens-adjusting module according to claim 2, wherein the tray further comprises a plurality of first sliding blocks, the first tray body further has a plurality of third sliding trenches, each of the third sliding trenches extends along the second axis and the first sliding blocks are capable of passing through the third sliding trenches respectively to be fixed at the second tray body such that the first tray body is movably disposed on the second tray body.

7. The lens-adjusting module according to claim 2, wherein the first tray body comprises a plurality of first sliding blocks, the second tray body has a plurality of third sliding trenches, each of the third sliding trenches extends along the second axis and the first sliding blocks are slidingly connected to the third sliding trenches respectively such that the first tray body is movably disposed on the second tray body.

8. The lens-adjusting module according to claim 2, further comprises a plurality of second sliding blocks, wherein the second tray body has a plurality of fourth sliding trenches, each of the fourth sliding trenches extends along the first axis, the first tray body further has a plurality of holes, the fourth sliding trenches are corresponding to the holes respectively, and the second sliding blocks are capable of passing through the fourth sliding trenches and the holes respectively to be fixed at the base such that the tray is movably disposed on the base.

9. The lens-adjusting module according to claim 8, wherein the tray limited by the holes has a first move distance along the first axis when the first tray body is at first position relative to the second tray body, the tray limited by the holes has a second move distance along the first axis when the first tray body is at a second position relative to the second tray body, and the first move distance is different from the second move distance.

10. The lens-adjusting module according to claim 2, wherein the tray further comprises an elastic piece disposed between the first tray body and the second tray body.

11. The lens-adjusting module according to claim 2, wherein the second transmission gear is a helical gear.

12. The lens-adjusting module according to claim 1, wherein the first transmission gear is a helical gear.

13. The lens-adjusting module according to claim 1, wherein the lens is directly disposed on the tray and the tray is directly disposed on the base.
